(19) United States
(12) Patent Application Publication
(10) Pub. No.: US 2007/0279902 A1
(43) Pub. Date: Dec. 6, 2007

(54) Light beam generator with extensible battery housing

(75) Inventor: Paul Y. Kim, Santa Ana, CA (US)

Correspondence Address: DAVID WEISS, 12650 RIVERSIDE DRIVE, SUITE 100, NORTH HOLLYWOOD, CA, 91607-3442, US

(73) Assignee: SUREFIRE, LLC

(21) Appl. No.: 11/447,422

(22) Filed: Jun. 5, 2006

(51) Int. Cl. F21L 4/04; H01M 2/10

(52) U.S. Cl. 362/202; 429/100; 429/9; 362/203

(57) ABSTRACT

A light beam generator having an extensible battery housing for accommodating batteries of different lengths. A preferred embodiment of a battery housing includes a first tubular member rearwardly extending from the light beam generator's light source housing and including first threads thereon, and a second tubular member in telescoping relation with the first tubular member, the second tubular member including second threads thereon threadedly engaging the first threads.

### BACKGROUND OF THE INVENTION

This invention relates to light beam generators, and more particularly to light beam generators having a battery housing for alternatively accommodating batteries of different lengths.

It is often useful for a battery-energized light beam generator, such as a handheld flashlight or a gun-mountable target illuminator or laser sight, to have the capability of carrying batteries of different lengths, or battery cells of different lengths and/or quantities of combined different lengths, for energizing the light emitter of the light beam generator. U.S. Pat. Nos. 6,046,572 and 6,345,464, to John W. Matthews and Paul Y. Kim, assigned to the assignee of the present invention and incorporated herein by reference, disclose light beam generators having battery housings adapted for carrying battery cells of different lengths but of the same combined or overall battery length, or adapted for replacing the battery housing or a section thereof for alternatively carrying batteries of different lengths. Also known in the art are light beam generators with replaceable battery housings of different lengths, or battery housings each of which is constructed by threadably securing separate tubular members together in fixed longitudinal relation.

### SUMMARY OF THE INVENTION

By the present invention, a light beam generator's battery housing is provided with an extensible structure for accommodating batteries of different lengths, and for accommodating longitudinally arranged battery cells of different quantities and/or different combined lengths. According to one aspect of the present invention, there is provided a light beam generator apparatus comprising: a generally cylindrical battery housing having a front opening; a rear cap for the battery housing including a battery rear terminal contact; a light source assembly including a battery front terminal contact; a light source housing for the light source assembly, the light source housing secured to the battery housing with the front terminal contact in the vicinity of the battery housing's front opening; and the battery housing being of a first length between the first and rear terminal contacts for accommodating a first generally cylindrical battery having a front terminal in contact with the front terminal contact and a rear terminal in contact with the rear terminal contact, the battery housing being longitudinally extensible to a second length between the front and rear terminal contacts for alternatively accommodating a second generally cylindrical battery of a length greater than the first battery and having a front terminal of the second battery in contact with the front terminal contact and a rear terminal of the second battery in contact with the rear terminal contact.

In a preferred embodiment, the battery housing includes: a first tubular member rearwardly extending from the light source housing and including first threads thereon; and a second tubular member in telescoping relation with the first tubular member, the second tubular member including second threads thereon threadedly engaging the first threads on the first tubular member. The first threads are on an external surface of one of the first and second tubular members (preferably of the first tubular member); and the second threads are on an internal surface of the other of the first and second tubular members (preferably of the second tubular member).

In one example, the first battery comprises a 6-volt battery such as two longitudinally aligned 3-volt battery cells; and the second battery comprises a 9-volt battery such as three longitudinally aligned 3-volt lithium battery cells, or a 4.5-volt battery such as three longitudinally aligned 1.5-volt AA battery cells.

According to another aspect of the present invention, there is provided in a light beam generator, apparatus comprising: a light source housing; a first tubular member rearwardly extending from the light source housing, the first tubular member including an externally threaded forward section and an externally threaded rearward section; and a second tubular member coaxial about the first tubular member and including an internally threaded section threadedly engaging the externally threaded forward section, the second tubular member adapted to be rotated about the first tubular member for disengaging the internally threaded section from the externally threaded forward section and for engaging the internally threaded section with the externally threaded rearward section. The first and second tubular members comprise a battery housing for accommodating a first battery of a first length when the internally threaded section of the second tubular member is engaged with the externally threaded forward section of the first tubular member and for accommodating a second battery of a second length different from the first length when the internally threaded section is disengaged from the externally threaded forward section and engaged with the externally threaded rear section.

The apparatus of the light beam generator preferably includes a rear cap for the second tubular member, and a battery rear terminal contact (preferably a spring contact) in the rear cap in contact with a rear terminal of the first battery when accommodated in the battery housing and alternatively in contact with a rear terminal of the second battery when accommodated in the battery housing. A switch is included in circuit with the first battery when accommodated in the battery housing and alternatively in circuit with the second battery when accommodated in the battery housing, which switch may be included in the rear cap.

According to yet another aspect of the present invention, there is provided in a light beam generator, apparatus comprising: a light source housing; a first tubular member rearwardly extending from the light source housing; a second tubular member in telescoping relation with the first tubular member; the tubular members being axially translatable with respect to each other between a first longitudinal position for accommodating a first battery within the tubular members and a second longitudinal position for accommodating a second battery of different length than the first battery within the tubular members. The first tubular member includes first threads thereon, preferably on the external surface thereof; and the second tubular member includes second threads thereon, preferably on the internal surface thereof, theadedly engaging the first threads when the tubular members are in their first longitudinal position and when the tubular members are in their second longitudinal position.

A still further aspect according to the present invention provides a method for accommodating batteries of different lengths in a light beam generator, comprising: providing the light beam generator with a battery housing including a first tubular member and a second tubular member telescoped with respect to the first tubular member for accommodating a battery of a first length within the first and second tubular members; and translating the second tubular member with respect to the first tubular member for longitudinally extending the battery housing to accommodate a second battery of a second length greater than the first length within the first and second tubular members.

### BRIEF DESCRIPTION OF THE DRAWINGS

The novel features believed to be characteristic of the present invention, together with further advantages thereof, will be better understood from the following description considered in connection with the accompanying drawings in which a preferred embodiment of the invention is illustrated by way of example. It is to be expressly understood, however, that the drawings are for the purpose of illustration and description only and are not intended as a definition of the limits of the invention.

FIG. 1 is a elevation view of a preferred embodiment of a light beam generator with an extensible battery housing in accordance with the present invention;

FIG. 2 shows the light beam generator of FIG. 1 with the battery housing in an extended configuration;

FIG. 3 is a longitudinal cross-section of a first tubular member included in the extensible battery housing of the light beam generator embodiment of FIGS. 1 and 2;

FIG. 4 is a longitudinal cross-section of a second tubular member included in the extensible battery housing of FIGS. 1 and 2;

FIG. 5 is a partial cross-sectional view of the light beam generator with the battery housing in its unextended position shown in FIG. 1, taken along the line 5-5 of FIG. 1 and viewed in the direction of the appended arrows, FIG. 5 showing two longitudinally arranged battery cells within the battery housing;

FIG. 6 is a partial cross-sectional view of the light beam generator with the battery housing in its extended position shown in FIG. 2, taken along the line 6-6 of FIG. 2 and viewed in the direction of the appended arrows, with three battery cells within the extended battery housing; and

FIG. 7 is a partial cross-sectional view of the light beam generator as shown in FIG. 6 but with two battery cells of longer length shown in the extended battery housing.

### DETAILED DESCRIPTION OF THE PREFERRED EMBODIMENT

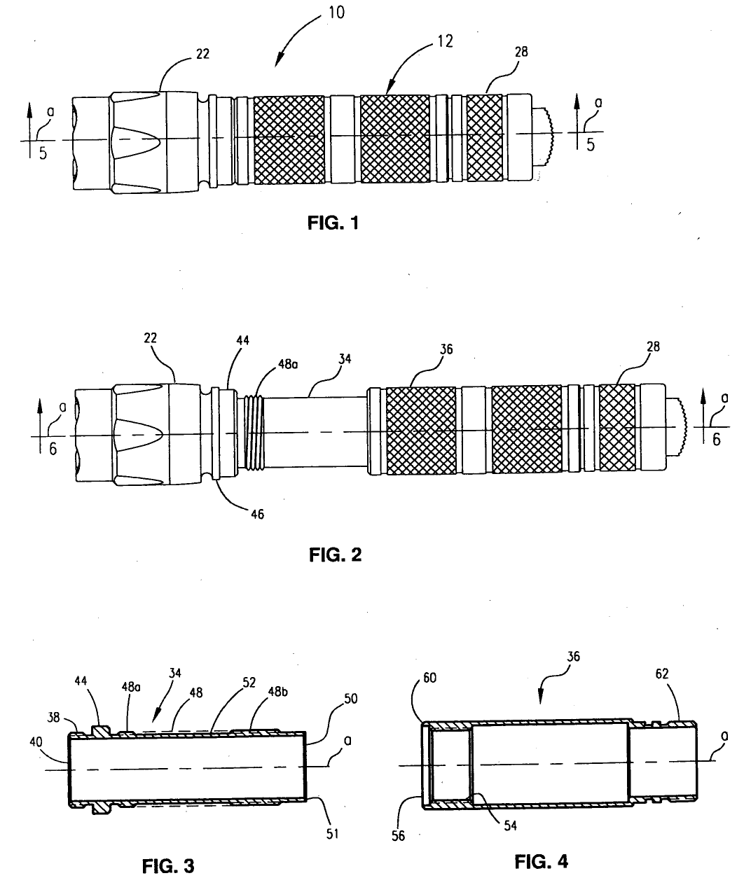

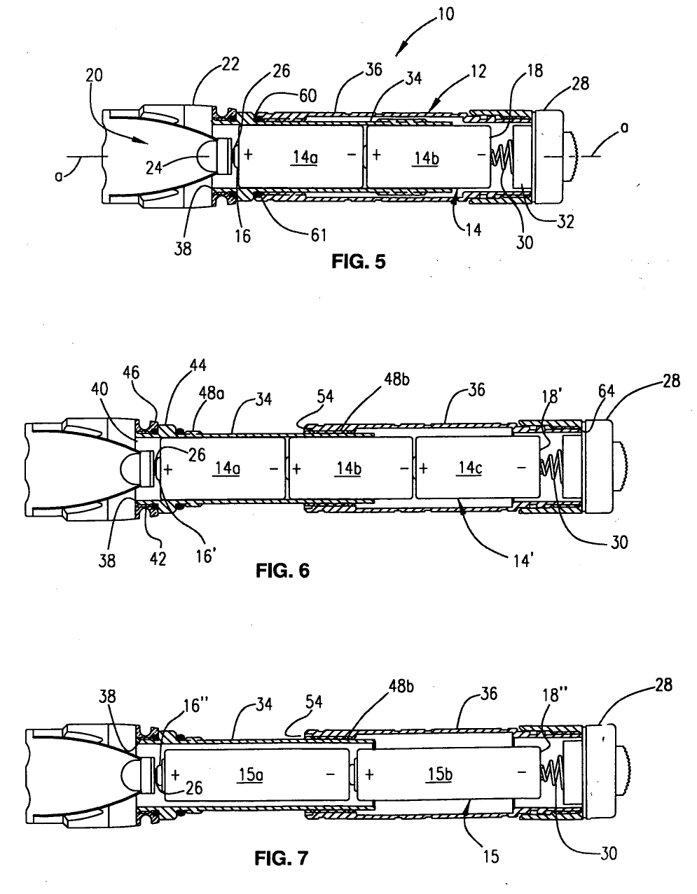

Turning to FIGS. 1 and 5, there is shown a preferred embodiment of a light beam generator in accordance with the present invention, specifically a flashlight 10 which may be conveniently held in the hand of a user. The flashlight 10 includes a generally cylindrical battery housing 12, for housing a generally cylindrical battery comprising at least one and typically a plurality of generally coaxially arranged series-contacting generally cylindrical battery cells. As shown in FIG. 5, the battery housing 12 contains a first battery 14 comprising two battery cells 14a, 14b coaxially arranged in series contact, i.e. with the positive terminal of one of the cells contacting the negative terminal of the other cell. The first battery 14 includes a front terminal 16 at the front end of the forward battery cell 14a, and further includes a rear terminal 18 at the rear end of the rearward battery cell 14b.

A light source assembly 20 is housed in a light source housing 22, and includes a light emitter or lamp such as an incandescent light bulb or a light emitting diode, preferably a high luminous flux LED 24. The light source assembly 20 further includes an electrical contact 26 contacting the front terminal 16 of the battery 14.

A rear cap 28 for the battery housing 12 includes an electrical contact such as spring contact 30 in contact with the rear terminal 18 of the battery 14. The electrically conductive battery housing is in circuit with the light source assembly 20 such as through contact between the battery housing and light source housing 22. The front and rear contacts 26, 30 permit the battery 14 to be in electrical circuit with the light source assembly 20. A switch, such as a pushbutton switch 32 housed in the rear cap 28, is included in the circuit for closing and opening the conductive path between the rear contact 30 and the battery housing 12 to cause the light emitter 22 of the light source assembly 20 to be selectively energized by the battery 14.

Flashlights to the extent thus far described may be of the type shown, for example, in U.S. Pat. No. 5,642,932 to John W. Matthews, and in U.S. Pat. No. 6,841,941 to Paul Y. Kim and William A. Hunt, the disclosures of each of which patents are incorporated in full herein by reference.

As used herein, “longitudinal” describes a direction substantially along the longitudinal axis a of the generally cylindrical battery housing 12; “front” or “forward” describes the longitudinal direction toward the light source housing 22 (i.e., to the left as shown in FIGS. 1-7); and “rear” or “rearward” describes the longitudinal direction opposite the front or forward direction (i.e., to the right as shown in FIGS. 1-7).

The improvement of the present invention, in its preferred embodiment, is concerned with the extensible structure of the light beam generator's battery housing 12 for accommodating batteries of different lengths, and for accommodating longitudinally arranged battery cells of different quantities and/or different combined lengths.

As shown in FIGS. 2-7, the battery housing 12 comprises a first tubular member 34 and a second tubular member 36 in telescoping relation. The first tubular member 34 is secured to and extends longitudinally rearwardly from the light source housing 22, as by threads 38 circumferentially about the first tubular member's front opening 40 in threaded engagement with cooperating threads 42 at the rear of the light source housing 22. The first tubular member 34 and the light source housing 22 are preferably fabricated of a conductive metal, with the threads 38, 42 effecting an electrically conductive communication between the first tubular member 34 and the light source housing 22. Such securement is preferably forwardly of a stop flange 44 of the first tubular member 34 in sealing engagement (by O-ring 45) with a rear shoulder 46 of the light source housing 22. The battery front terminal contact 26 of the light source assembly 20 is situated in the vicinity of the front opening 40 of the first tubular member 34.

The first tubular member 34 further includes threads 48 circumferentially on the external or outer surface of the first tubular member 34 and rearwardly extending from the vicinity of the flange 44. The threads 48 may extend through the vicinity of the rear edge 50 at the rear opening 51 of the first tubular member 34, as shown in phantom in FIG. 3, and include a threaded forward section 48a and a threaded rearward section 48b. In the preferred embodiment, the threaded rearward section 48b is separated from the threaded forward section 48a by a non-threaded section 52, the purpose of which will become clear later in this specification.

The second tubular member 36 has an inside diameter nominally larger than the outside diameter of the first tubular member 34. The second tubular member 36 is coaxially mounted about the first tubular member 34 and is longitudinally translatable with respect to the first tubular member 34. In the preferred embodiment, such translatable mounting is implemented by threads 54 on the internal or inner surface of the second tubular member 36, preferably in the vicinity of the front opening 56 of the second tubular member 36, for threadedly engaging the external threads 48 of the first tubular member 34.

In assembling the battery housing 12, a user may coaxially place the second tubular member 36 to the first tubular member 34 with the first tubular member's rear edge 50 received by the second tubular member's front opening 56. The user then rotates the second tubular member 36 with respect to the first tubular member 34, thereby causing the threads 54 to threadedly engage the threads 48 (specifically the threaded rearward section 48b) of the first tubular member 34 and forwardly translating the second tubular member 36 along the first tubular member 34. If the threads 48 are continuous from section 48b through section 48a, the user may continue such rotation and consequent translation until the threads 54 engage the threaded forward section 48a and the second tubular member's front edge 60 is sealingly (by O-ring 61) stopped by the stop flange 44, as shown in FIG. 5. If the threads 48 comprise only the threaded forward section 48a and the threaded rearward section 48b, the user may forwardly urge the second tubular member 36 for translating the second tubular member 36 along the first tubular member 34 after the second tubular member's threads 54 have cleared and have been disengaged from the threaded rearward section 48b, until the threads 54 reach the threaded forward section 48a. The user thereupon again rotates the second tubular member 36 for threadedly engaging the threads 54 with the threaded forward section 48a, for forwardly translating the second tubular member 36 until the second tubular member's forward edge 60 is sealingly (by O-ring 61) stopped by the stop flange 44 of the first tubular member 34, as shown in FIG. 5.

It may be appreciated that the first and second tubular members 34, 36 are structurally and electrically secured together whenever the second member's threads 54 engage the first tubular member's threads 48, and in the preferred embodiment whenever the second member's threads 54 engage either the threaded forward section 48a or the threaded rearward section 48b of the first tubular member 34.

The second tubular member 36 further includes a rear threaded portion 62 for threadedly engaging cooperating threads 64 of the rear cap 28, for securing the rear cap 28 to the second tubular member 36. A conductive path between the second tubular member 36 and the rear cap 28 (for example through the threaded connection of the second tubular member 36 to the preferably conductive metal cap 28) places the spring contact 30 in circuit through the pushbutton switch 32 housed in the rear cap 28.

The battery housing 12 is in its unextended configuration when the second tubular member 36 is in its most forwardly translated position telescoped about nearly the entire length of the first tubular member 34 as described above and as shown in FIGS. 1 and 5. In this unextended configuration, in the example shown, the length of the battery housing 12 is such that the distance between the front and rear battery terminal contacts 26, 30 is predetermined for holding two battery cells 14a and 14b in longitudinally series-contacting relation, such as two 3-volt lithium battery cells (e.g., size 123A). The two battery cells 14a, 14b may be inserted in the battery housing 12 by removing the rear cap 28, placing the two battery cells 14a, 14b coaxially in the battery housing 12 with the front battery terminal 16 (e.g., the positive terminal of the forward battery cell 14a) in contact with the light source assembly's front battery terminal contact 26, and threadedly replacing the rear cap 28 onto the second tubular member 36 until the rear cap's spring contact 30 is biased against the battery's rear terminal 18 (e.g., the negative terminal of the battery cell 14b), as shown in FIG. 5.

When it is desired to utilize a different battery of a greater length within the battery housing 12, the user may place the battery housing 12 into its extended configuration by unthreadingly rotating the second tubular member 36 with respect to the first tubular member's threaded forward section 48a and rearwardly translating the second tubular member 36 with respect to the first tubular member 34 until the second tubular member's threads 54 engage the first tubular member's threaded rearward section 48b. After removing the rear cap 28, the user may insert a different battery of a greater length than the first battery 14 into the battery housing 12, substituting the second or greater length battery for the first battery. For example, a second or greater length battery 14 may comprise three 3-volt lithium battery cells 14a, 14b and 14c placed into the battery housing 12 in longitudinally series-contacting relation, with the front battery terminal 16′ (e.g., the positive terminal of the forward battery cell 14a) in contact with the light source assembly's front battery terminal contact 26 as shown in FIG. 6. Alternatively, the user may insert a different battery of greater length than the first battery 14 but of substantially the same or slightly lesser diameter, e.g. a second battery 15 comprising two 1.5-volt size AA batteries 15a, 15b in longitudinally series-contacting relation and with the front battery terminal 16″ (e.g., the positive terminal of the forward battery cell 15a) contacting the light source assembly's front battery terminal contact 26 as shown in FIG. 7. In either case, the user threadedly replaces the rear cap 28 onto the second tubular member 36, and the user may rotate the second tubular member 36 with respect to the first tubular member 34 for translatingly adjusting the position of the second tubular member's threads 54 with respect to the first tubular member's threaded rearward section 48b until the rear cap spring contact 30 is biased against the rear terminal 18′ or 18″ of the longer battery 14′ or 15 (e.g., the negative terminal of the rear battery cell 14c as shown in FIG. 5 or the negative terminal of the rear battery cell 15b as shown in FIG. 6). If desired, the front battery terminal contact 16 may comprise a spring contact.

As previously noted, in the preferred embodiment of the light beam generator or flashlight 10 according to the present invention, the threads 48 are disposed on the external or outer surface of the first tubular member 34 while the threads 54 are disposed on the internal or inner surface of the second tubular member 36. In other embodiments, it may be advantageous to place the threads 48 on the internal or inner surface of the first tubular member 34 while placing the threads 54 on the external or outer surface of the second tubular member 36, and such disposition of the threads 48 and 54 are included within the scope of the present invention. In such case the inner diameter of the first tubular member 34 will be substantially the same as or nominally greater than the outer diameter of the second tubular member 36, for permitting the second tubular member 36 to telescope or to be coaxially translated within the first tubular member 34.

An important advantage of the extensible battery housing 12 of the present invention is its self-contained structure, so that a user in the field is not required to dismantle the battery housing of his/her light beam generator or flashlight and add tubular members or other parts thereto or to remove tubular members or other parts therefrom or to substitute different housings in order to accommodate batteries of different lengths.

Thus, there has been described a preferred embodiment of a light beam generator having an extensible battery housing for accommodating batteries of different lengths, and for accommodating longitudinally arranged battery cells of different quantities and/or of different combined lengths. Other embodiments of the present invention, and variations of the embodiment described herein, may be developed without departing from the essential characteristics thereof. Accordingly, the invention should be limited only by the scope of the claims listed below.

I claim:

1. Light beam generator apparatus, comprising:
a generally cylindrical battery housing having a front opening;
a rear cap for said battery housing including a battery rear terminal contact;
a light source assembly including a battery front terminal contact;
a light source housing for said light source assembly, said light source housing secured to said battery housing with said front terminal contact in the vicinity of said front opening; and
said battery housing being of a first length between said front and rear terminal contacts for accommodating a first generally cylindrical battery having a front terminal in contact with said front terminal contact and a rear terminal in contact with said rear terminal contact, said battery housing being longitudinally extensible to a second length between said front and rear terminal contacts for alternatively accommodating a second generally cylindrical battery of a length greater than the first battery and having a front terminal of the second battery in contact with said front terminal contact and a rear terminal of the second battery in contact with said rear terminal contact.

2. The apparatus according to claim 1, wherein said battery housing includes:
a first tubular member rearwardly extending from said light source housing and including first threads thereon; and
a second tubular member in telescoping relation with said first tubular member, said second tubular member including second threads thereon threadedly engaging said first threads.

3. The apparatus according to claim 2, wherein:
said first threads are on an external surface of one of said first and second tubular members; and
said second threads are on an internal surface of the other of said first and second tubular members.

4. The apparatus according to claim 2, wherein:
said first threads are on an external surface of said first tubular member; and
said second threads are on an internal surface of said second tubular member.

5. The apparatus according to claim 1, wherein:
the first battery comprises a 6-volt battery; and
the second battery comprises a 9-volt battery.

6. The apparatus according to claim 5, wherein:
the 6-volt battery comprises two generally longitudinally aligned 3-volt battery cells; and
the 9-volt battery comprises three generally longitudinally aligned 3-volt battery cells.

7. The apparatus according to claim 1, wherein:
the first battery comprises a 6-volt battery; and
the second battery comprises a 4.5-volt battery.

8. The apparatus according to claim 7, wherein:
the 6-volt battery comprises two generally longitudinally aligned 3-volt battery cells; and
the 4.5-volt battery comprises three generally longitudinally aligned 1.5-volt battery cells.

9. In a light beam generator, apparatus comprising:
a light source housing;
a first tubular member rearwardly extending from said light source housing, said first tubular member including an externally threaded forward section and an externally threaded rearward section; and
a second tubular member coaxial about said first tubular member and including an internally threaded section threadedly engaging said externally threaded forward section, said second tubular member adapted to be rotated about said first tubular member for disengaging said internally threaded section from said externally threaded forward section and for engaging said internally threaded section with said externally threaded rearward section.

10. The apparatus according to claim 9, wherein:
said first and second tubular members comprise a battery housing for accommodating a first battery of a first length when said internally threaded section of said second tubular member is engaged with said externally threaded forward section of said first tubular member, and for accommodating a second battery of a second length different than said first length when said internally threaded section is disengaged from said externally threaded forward section and engaged with said externally threaded rear section.

11. The apparatus according to claim 10, including:
a rear cap for said second tubular member.

12. The apparatus according to claim 10, including:
a switch in circuit with the first battery when accommodated in said battery housing and alternatively in circuit with the second battery when accommodated in said battery housing.

13. The apparatus according to claim 12, wherein:
said switch is included in a rear cap for said second tubular member.

14. The apparatus according to claim 11, wherein:
said rear cap includes a battery rear terminal contact in contact with a rear terminal of the first battery when accommodated in said battery housing and alternatively in contact with a rear terminal of the second battery when accommodated in said battery housing.

15. The apparatus according to claim 14, wherein:
said rear terminal contact comprises a spring contact.

16. The apparatus according to claim 14, including a light source assembly in said light source housing, wherein:
said light source assembly includes a battery front terminal contact in contact with a front terminal of the first battery when accommodated in said battery housing and alternatively in contact with a front terminal of the second battery when accommodated in said battery housing.

17. In a light beam generator, apparatus comprising:
a light source housing;
a first tubular member rearwardly extending from said light source housing;
a second tubular member in telescoping relation with said first tubular member;
said tubular members being axially translatable with respect to each other between a first longitudinal position for accommodating a first battery within said tubular members and a second longitudinal position for accommodating a second battery of different length than the first battery within said tubular members.

18. The apparatus according to claim 17, wherein:
said first tubular member includes first threads thereon; and
said second tubular member includes second threads thereon threadedly engaging said first threads when said tubular members are in said first longitudinal position and when said tubular members are in said second longitudinal position.

19. The apparatus according to claim 18, wherein:
said first threads are on an external surface of one of said first and second tubular members; and
said second threads are on an internal surface of the other of said first and second tubular members.

20. The apparatus according to claim 18, wherein:
said first threads are on an external surface of said first tubular member; and
said second threads are on an internal surface of said second tubular member.

21. The apparatus according to claim 17, including:
a rear cap for said second member.

22. The apparatus according to claim 21, wherein:
said rear cap includes a battery rear terminal contact in contact with a rear terminal of the first battery when accommodated in said tubular members in said first longitudinal position and alternatively in contact with a rear terminal of the second battery when accommodated in said tubular members in said second longitudinal position.

23. The apparatus according to claim 22, including a light source assembly in said light source housing, wherein:
said light source assembly includes a battery front terminal contact in contact with a front terminal of the first battery when accommodated in said tubular members in said first longitudinal position and alternatively in contact with a front terminal of the second battery when accommodated in said tubular members in said second longitudinal position.

24. The apparatus according to claim 23, wherein:
at least one of said rear terminal contact and said front terminal contact comprises a spring contact.

25. The apparatus according to claim 23, wherein:
said rear terminal contact comprises a spring contact.

26. A method for accommodating batteries of different lengths in a light beam generator, comprising:
providing a light beam generator with a battery housing including a first tubular member and a second tubular member telescoped with respect to said first tubular member for accommodating a battery of a first length within said first and second tubular members; and
translating said second tubular member with respect to said first tubular member for longitudinally extending said battery housing to accommodate a second battery of a second length greater than said first length within said first and second tubular members.
